(19) United States
(12) Patent Application Publication
(10) Pub. No.: US 2006/0288642 A1
(43) Pub. Date: Dec. 28, 2006

(54) Anti-pinch system using pressure-sensitive rubber

(76) Inventor: Leslie Joseph Marentette, Newmarket (CA)

Correspondence Address: CLARK HILL, P.C., 500 WOODWARD AVENUE, SUITE 3500, DETROIT, MI, 48226, US

(21) Appl. No.: 11/474,709

(22) Filed: Jun. 26, 2006

Related U.S. Application Data
(60) Provisional application No. 60/693,874, filed on Jun. 24, 2005.

(51) Int. Cl. E05F 15/10

(52) U.S. Cl. 49/26

(57) ABSTRACT

An anti-pinch system for a vehicle opening device, such as a window regulator, that includes a pressure sensitive resistive coupler located between a gear and a damper plate in the vehicle opening device. When the load is increased on the vehicle opening device, the resistive coupler compresses, altering its electrical resistance. An electrical circuit runs through the resistive coupler, and the circuits resistance is measured. A controller for the device's motor is operable to adjust the velocity of the motor based upon changes in resistance in the damper. Preferably, the controller compares changes in measured resistance to an expected change in resistance based upon the opening device's position to determine whether a pinch condition has occurred.

### FIELD OF THE INVENTION

The present invention relates to powered window regulators for motor vehicles. More specifically, the present invention relates to safety devices used to detect pinching conditions in order to protect both individuals and the motor vehicle.

### BACKGROUND OF THE INVENTION

Power window are a popular feature on many vehicles. Typically, a user activates a switch to engage an electric motor that raises or lowers the window glass a vehicle door. However, there is a risk of harm to individuals, objects and the window glass when obstacles are caught between the moving window and the doorframe. To mitigate harm to both individuals and objects, anti-pinching systems have become an important safety feature. Current window regulator anti-pinch technology typically relies upon hall-effect sensors to determine the position of the window glass relative to its fully open or closed position. This signal can be integrated to calculate the velocity of the window glass. When used in conjunction with motor current measurement, the instantaneous output torque of the motor can be calculated within a reasonable margin of error. The instantaneous torque of the motor can be compared to a position vs. torque matrix, to determine if the motor is producing normal or excess torque at this position. If the torque output is excessive, the controller will stop or even reverse the motor to prevent damage from occurring to either the window regulator system or the obstacle in its path.

While anti-pinch technology using hall-effects sensors and current-sensing circuitry can provide a degree of protection, it is not without its drawbacks. The use of hall-effects and current sensing circuitry drives up the cost of the window regulator controller, as a more powerful microprocessor is required. In addition, the calculated instantaneous torque provides a relatively incomplete picture of the window regulator load performance, from which a “go/no go” decision must be made. The need to respond quickly to infrequently updated torque data is a major contributor to false tripping of the anti-pinch circuit. It is therefore desirable to provide a more responsive, reliable and less expensive anti-pinching system for a window regulator.

### SUMMARY OF THE INVENTION

According to a first aspect of the invention, there is provided an apparatus for detecting a pinch condition in a vehicle opening device, comprising

an electric motor;

a gear, driven by the electric motor;

a damper plate, driven by the gear and operatively coupled to the vehicle opening device to move the vehicle opening device between an open and a closed position;

a pressure sensitive resistive coupler connecting the gear to the damper plate, the resistive coupler varying its electrical resistance when compressed by the motion of the damper plate relative to the gear;

at least two electrical terminals interconnected by the resistive coupler to form a circuit;

a controller for the electric motor, operable to measure at least one operating characteristic in the circuit and compare a measured value for the operating characteristic against a predetermined value to determine whether a pinch condition exists.

According to a second aspect of the invention, there is provided a method for detecting a pinch condition in a vehicle closure device, comprising:

measuring the electrical resistance in a pressure sensitive resistive coupler that varies its electrical resistance due to compression, and where increasing the load on the vehicle closure device compresses the resistive coupler; and

comparing changes in the measured electrical resistance to a predetermined threshold to determine if a pinch condition exists.

The present invention eliminates the need to calculate window glass velocity or to measure motor current in order to measure torque in the window regulator. Instead, the invention measures electrical resistance as it corresponds to torque. In addition, the invention provides a quicker response than prior art anti-pinch systems at a reduced cost.

### DESCRIPTION OF THE DRAWINGS

Preferred embodiments of the present invention are described in detail below with reference to the accompanying illustrations in which:

FIG. 1 shows a vehicle door for a vehicle equipped with a window regulator;

FIG. 2 shows a dis-assembled view of the motor assembly for the window regulator shown in FIG. 1;

FIG. 3 shows a plan view of a first side of the worm gear shown in FIG. 2;

FIG. 4 shows a plan view of the second side of the worm gear shown in FIG. 2;

FIGS. 5a and 5b show a partial sectional view of the motor assembly shown in FIG. 2 under no load and load conditions; and

FIG. 6 shows a diagrammatic view of a controller for the motor assembly shown in FIG. 2.

### DETAILED DESCRIPTION OF THE INVENTION

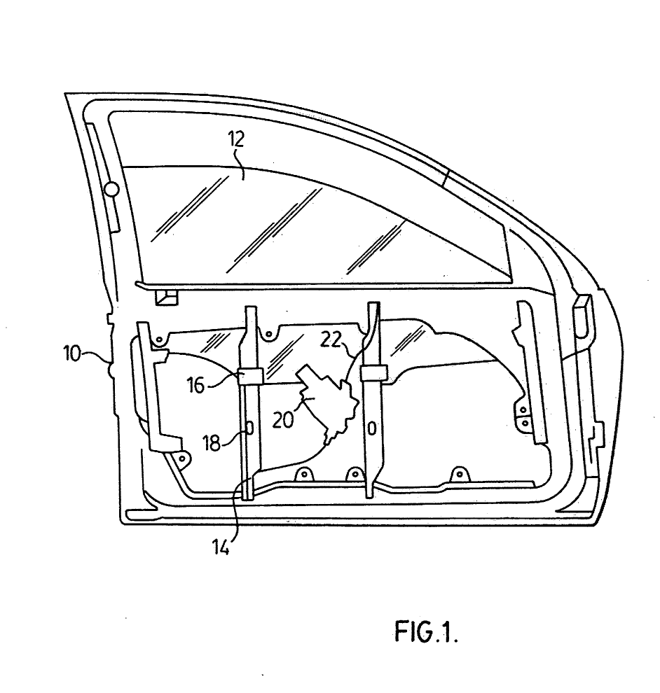

Referring now to FIG. 1, a vehicle door 10 is shown, having a movable window glass 12. Window glass 12 is raised or lowered by a window regulator 14, and moves between an open and a closed position. In the presently illustrated embodiment, window regulator 14 includes a pair of lift plates 16 that slide along a pair of rails 18. Window glass 12 is mounted into the two lift plates 16. An electric motor assembly 20 rotates a cable drum(not shown), thereby raising or lowering the lift plates 16 via cables 22. The implementation of window regulator 14 is not particularly limited. For instance, window regulator 14 could use single or dual rails 18. Instead of dual lift plates, window regulator 14 could use a single lift plate 16 spanning between two rails 18 Alternatively, window regulator 14 could use a scissor configuration. Other types of window regulators will occur to those of skill in the art.

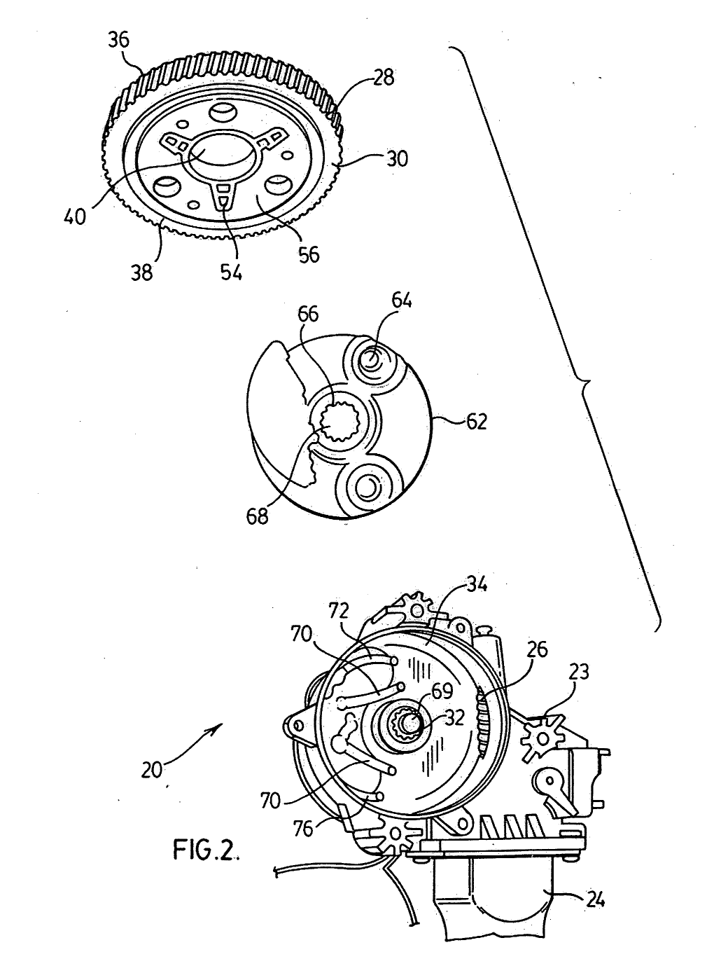

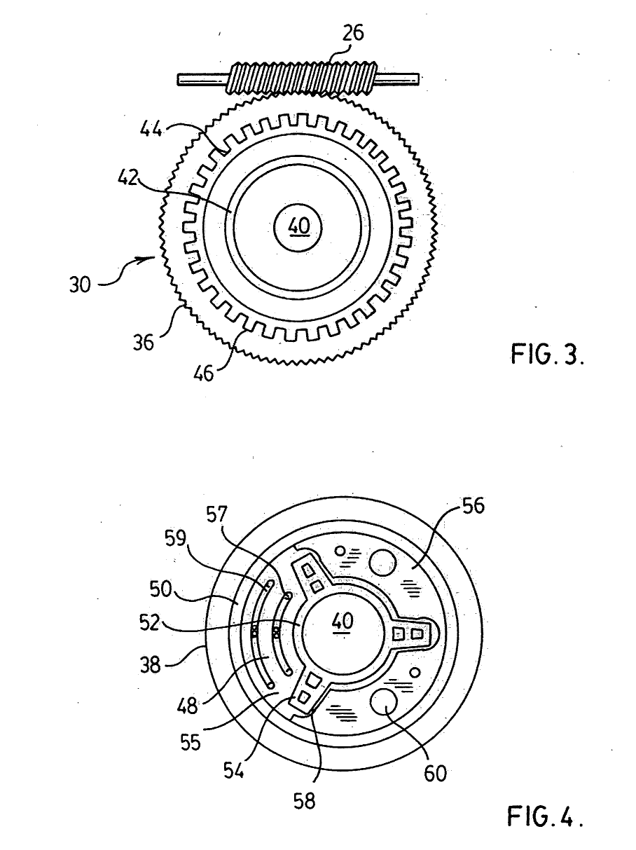

Referring now to FIG. 2, motor assembly 20 is shown in greater detail. Motor assembly 20 includes a plastic housing 23 and a reversible DC motor 24. DC motor 24 drives a worm 26. Worm 26 intermeshes with a set of teeth 28 located on a gear, namely, plastic worm wheel 30. Worm wheel 30 is rotably mounted around annular post 32 within a gear chamber 34 in housing 23. Worm wheel 30 provides a first surface 36 facing housing 23 and a second opposed surface 38. A central aperture 40 is provided in the middle of worm wheel 30. As can best be seen in FIG. 3, a conductive inner slip ring 42 and an outer slip ring 44 are concentrically mounted on first surface 36 around central aperture 40. Outer slip ring 44 includes a number of evenly-spaced outwardly extending teeth 46.

As can best be seen in FIG. 4, a recessed region 48 is provided in second surface 38 between an outer annular wall 50 and an inner annular wall 52 that defines the periphery of central aperture 40. A number of evenly distributed radial walls 54 extend out from inner annular wall 52 towards outer annular wall 50, partially dividing recessed region 48 into a number of equally sized sectors 55. The radial walls 54 do not extend all the way to outer ring wall 50, but instead leave a gap therebetween. Within each sector 55 is a pair of conductive strips 57 and 59 along second surface 38. Conductive strips 57 and 59 are electrically isolated from each other, but are in electrical contact with inner slip ring 42 and outer slip ring 44, respectively, via terminal connectors that extend through worm wheel 30.

A pressure-sensitive coupler ring 56 is mounted within recessed region 48. Coupler ring 56 is manufactured from a pressure sensitive conductive rubber such as Zoflex™ that varies in its electrical resistance when compressed. In the present embodiment, the electrical resistance of coupler ring 56 decreases as pressure is applied. Coupler ring 56 includes contoured scallops 58 that are fitted around radial walls 54, providing a tight fit. A plurality of concave divots 60 are provided on the surface of coupler ring 56, facing away from worm wheel 30. While coupler ring 56 is described here as an integral ring, it could also be subdivided into a number of arc segments arranged together to fill recessed region 48.

A damper plate 62 (FIG. 2) abuts against coupler ring 56. Damper plate 62 is a substantially flat disk, having a plurality of studs 64 extending from the surface of damper plate 62 and spaced as to be located within divots 60 in coupler ring 56. A ring of teeth 66 is provided in damper plate 62 around the edges of a central aperture 68. A shaft 69 from the cable drum (not shown) is sized as to extend through apertures 40 and 68, and mesh with ring of teeth 66 on damper plate 62.

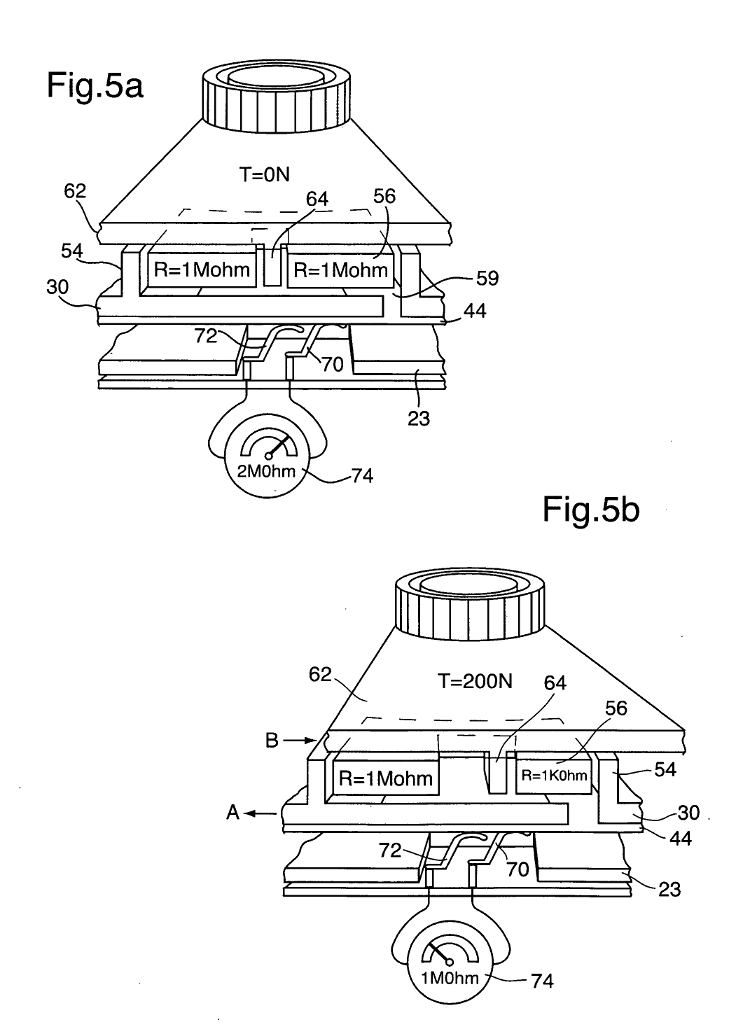

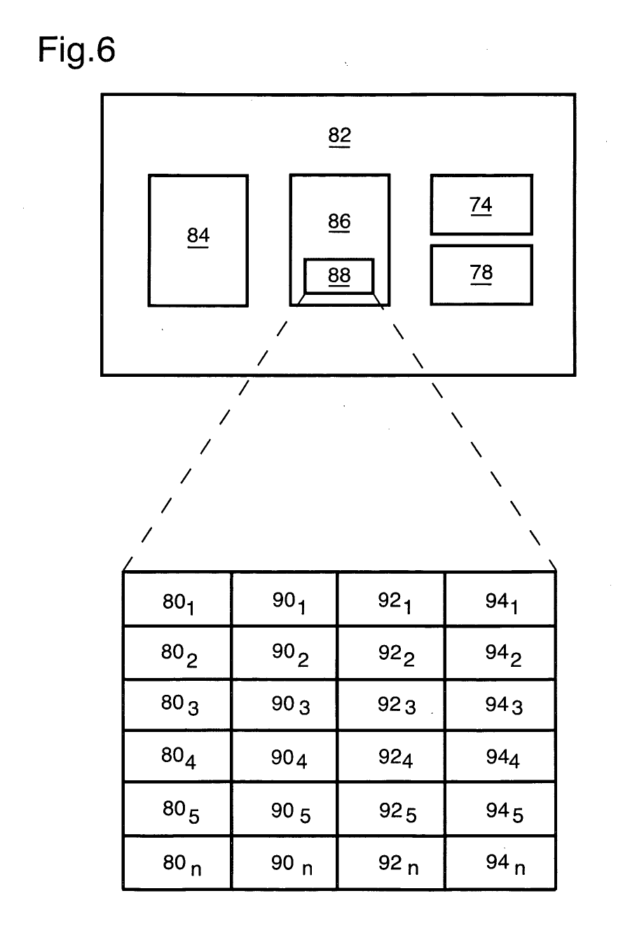

A pair of electrically connected feelers arms 70, 72 is mounted to the surface of housing 23 within gear chamber 34. Feeler arms 70, 72 are spring-loaded and biased away from housing 23 to abut against inner slip ring 42 and outer slip ring 46 respectively. The coupler ring 56 extends between inner slip ring 42 and outer slip ring 46, thus forming a circuit between feeler arms 70,72. The feeler arms 70, 72 are connected to a resistance sensor 74 (FIG. 5) that measures the resistance in coupler ring 56 between inner slip ring 42 and outer slip ring 44. Alternatively, other operating characteristics of the circuit, such as voltage or current could be measured by a sensor connected to one of the feeler arms 70, 72. Another feeler arm 76 (not shown) is connected to a position sensor 78 (FIG. 6) and is positioned as to be in periodic contact with teeth 46 on outer slip ring 44 when worm wheel 30 rotates. Since feeler arm 72 provides constant power through outer slip ring 44, position sensor 78 pulses on every time feeler arm 76 contacts one of the teeth 46.

FIG. 5a shows the worm wheel 30 and damper plate 62 operating under a normal, non-load condition. FIG. 5b shows the worm wheel 30 and damper plate 62 operating under a load condition of 200 N. Engaging DC motor 24 drives worm 26 in the direction indicated by arrow A. Worm 26, in turn, drives worm wheel 30. Worm wheel 30 drives damper plate 62, which in turn, drives window regulator 14. The resistance of coupler ring 56 is measured by resistance sensor 74 as approximately 2 Mohms. When a load is applied to window glass 12 (i.e., a potential pinch condition occurs), the load is transferred through window regulator 14 to damper plate 62 in the direction indicated by arrow B. Studs 64 compress a portion of ring 56 against radial walls 64. Under compression, the electrical resistance of coupler ring 56 drops from approximately 2 Mohms to 1 Mohms.

By measuring the number of pulses in feeler arm 76, position sensor 78 can track the total rotational distance of worm wheel 30, and by extension, the position of window glass 12. The total travel distance of window glass 12 between its open and its closed position can be divided into a number of regions 80ₙ, (FIG. 1) that each correspond to one full rotation of worm wheel 30. The size of each region 80ₙ is not particularly limited, and each region 80ₙ, can be sized to be a different multiple number of rotations of worm wheel 30. Alternatively, if smaller regions are desired, each region 80ₙ can be sized to be a fraction of a rotation of worm wheel 30. Rotating worm wheel 30 in a direction to raise window glass 12 increases the region count and rotating worm wheel 30 in the opposite direction to lower window glass 12 decreases the region count.

Referring now to FIG. 6, resistance sensor 74 and position sensor 78 are located within, or otherwise implemented by, a controller 82. Controller 82 includes a processor 84, which can be a microprocessor, micro-controller or application specific integrated circuit (ASIC), and a memory unit 86, which can be any non-volatile memory, such as ROM, EEPROM or FLASH memory. Controller 82 receives or calculates the resistance values from resistance sensor 74 for each region 80ₙ and calculates a resistance delta 90ₙ between the current window regions 80ₙ and the previous window region 80ₙ₋₁. The resistance delta 90ₙ is stored in an array 88 within memory unit 86. Array 88 also contains expected resistance deltas 92ₙ for each region 80ₙ. As motor assembly 20 raises window glass 12, processor 84 compares resistance delta 90ₙ to the expected resistance delta 92ₙ. If resistance delta 90ₙ is varies from (in the preferred embodiment, is less than) the expected resistance delta 92ₙ by more than a predetermined threshold, a pinch condition has been detected. Depending on the severity of the pinch condition detected, processor 84 can slow, stop or even reverse the direction of DC motor 24. It is contemplated that processor's response to the detected pinch condition could vary depending on which region 80 window glass 12 is currently located in. For instance, DC motor 24 could slow down if window glass 12 relatively far from its closed position, stop if window glass 12 is close to its closed position, and reverse if window glass 12 is within its final window region 80.

Temperature changes, particularly the extremes of winter and summer, have been known to temporally alter resistance values for window regulator 14. Rubber seals expand and contract, and ice can form between the seals and window glass 12. Thus, processor 84 may temporally adjust the expected resistance delta 92ₙ in array 88 by a specific amount based upon information provided by an external temperature sensor (not shown). In addition to temporary seasonal variances, resistance deltas for the window regulator 14 in different region 80ₙ may drift due to wear and tear on the vehicle. Rubber seals may harden or contract, worm efficiency may deteriorate, cabling may begin to slip, etc. Thus, array 88 can maintain a column of previously measured resistance deltas 94ₙ for each region 80ₙ. As the resistance values for each region 80ₙ change, controller 82 may update the expected resistance delta 90ₙ in array 88 in order to prevent both false or premature pinch detections or belated pinch detections. It should also be appreciated that the expected or resistance values may be dynamically calculated during operation of the window regulator 14. It should also be appreciated that the invention is not particularly limited and can be applied to opening devices other than window regulators, such as power lift gates, etc. Other opening devices will occur to those of skill in the art.

What is claimed is:

1. An apparatus for detecting a pinch condition in a vehicle opening device, comprising
an electric motor;
a gear, driven by the electric motor;
a damper plate, driven by the gear and operatively coupled to the vehicle opening device to move the vehicle opening device between an open and a closed position;
a pressure sensitive resistive coupler connecting the gear to the damper plate, the resistive coupler varying its electrical resistance when compressed by the motion of the damper plate relative to the gear;
at least two electrical terminals interconnected by the resistive coupler to form a circuit;
a controller for the electric motor, operable to measure at least one operating characteristic in the circuit and compare a measured value for the operating characteristic against a predetermined value to determine whether a pinch condition exists.

2. The apparatus of claim 1, wherein the controller is further operable to adjust the velocity of the electric motor when the measured value differs from the predetermined value.

3. The apparatus of claim 1, wherein the at least one operating characteristic in the circuit is one of current, resistance and voltage.

4. The apparatus of claim 3, wherein the pressure sensitive resistive coupler is made from pressure sensitive conductive rubber.

5. The apparatus of claim 4, wherein the at least two terminals comprises:
a first conductive ring located on the surface of the gear and in electrical contact with the pressure sensitive resistive coupler;
a second conductive ring spaced apart concentrically from the first conductive ring and in electrical contact with the pressure sensitive resistive coupler;
a pair of first terminal arms, in electrical contact with the first conductive ring and connected to the vehicle's power supply; and
a second terminal arm, in electrical contact with the second conductive ring and connected to the sensor that measures resistance.

6. The apparatus of claim 5, further including:
a plurality of teeth spaced around the second conductive ring;
a third terminal arm in periodic contact with one of the plurality of teeth when the gear rotates; and
wherein the controller is operable to count the number of contacts made between the third terminal arm the plurality of teeth, and thereby calculate the total distance of rotation of the gear.

7. The apparatus of claim 6, wherein the controller is operable to determine the position of the vehicle-opening device based upon the total distance of rotation of the gear.

8. The apparatus of claim 7, wherein the controller is operable to determine an expected change in resistance based upon the position of vehicle opening device, and where the expected change in resistance is used to determine the predetermined threshold.

9. The apparatus of claim 8, wherein the controller is operable to adjust the predetermined threshold based upon inputs from at least one other sensor.

10. The apparatus of claim 9, wherein the at least one other sensors includes an external temperature sensor.

11. The apparatus of claim 8, wherein the controller is operable to store in a memory unit the measured change of resistance in the circuit at different positions of the vehicle opening device, and is further operable to adjust the expected change in resistance based upon previously recorded measured change of resistances located in the memory unit.

12. A method for detecting a pinch condition in a vehicle closure device, comprising:
measuring the electrical resistance in a pressure sensitive resistive coupler that varies its electrical resistance due to compression, and where increasing the load on the vehicle closure device compresses the resistive coupler; and
comparing changes in the measured electrical resistance to a predetermined threshold to determine if a pinch condition exists.

13. The method of claim 12, further comprising:
determining the position of the vehicle closure device relative to its open and closed positions;
determining an expected change in resistance for the vehicle closure device at its current position, and where the predetermined threshold is based upon the expected change in resistance.

14. The method of claim 13, further comprising adjusting the predetermined threshold based upon inputs from at least one other sensor.

15. The method of claim 14, wherein the at least one other sensor includes an external temperature sensor.

16. The method of claim 13, further comprising:
storing in a memory unit the measured change of resistance in the pressure sensitive damper at different positions of the vehicle opening device; and
adjusting the predetermined threshold based upon previously recorded measured changes of resistance located in the memory unit.
